(19) United States
(12) Patent Application Publication
(10) Pub. No.: US 2002/0051455 A1
(43) Pub. Date: May 2, 2002

(54) MAC protocol over ATM passive optical network

(76) Inventors: Yu Tae Lee, Busan (KR); Seung Hwan Kim, Taejon (KR); Pil Joo Moon, Seoul (KR)

Correspondence Address: JACOBSON HOLMAN, PLLC., PROFESSIONAL LIMITED LIABILITY COMPANY, 600 Seventh Street, N.W., Washington, DC, 20004, US

(21) Appl. No.: 09/984,743

(22) Filed: Oct. 31, 2001

(30) Foreign Application Priority Data
Oct. 31, 2000 (KR) 2000-64268

(51) Int. Cl. H04L 12/56

(52) U.S. Cl. 370/395.21; 370/442

(57) ABSTRACT

A medium access control (MAC) technique between a group of optical network units (ONU) and an optical line termination (OLT) on an asynchronous transfer mode passive optical network (ATM-PON) is disclosed. The downstream frame from the OLT to the group of ONUs includes PLOAM cells having data grant fields, PLOAM grant fields and divided-slot grant fields whose format, being allocated with different identification bit values, is distinguished one from another. The upstream frame from the group of ONUs to the OLT includes a divided-slot structure of 56-byte size, which is divided into four 14-byte minislots for transmitting cell information on the number of real-time cells and non-real-time cells that have arrived at a corresponding ONU. The data grant field format has a quality of service (QoS) class bit allocated for classifying real-time or non-real-time traffics, thus improving the efficiency of utilization as well as efficient transmission.

### FIELD OF THE INVENTION

The present invention relates to a medium access control (MAC) protocol in an asynchronous transfer mode (ATM) passive optical network (PON); and more particularly to a transmit frame structure and a method applied to embody the protocol, and an ONU and OLT for embodying the protocol. Also, the present invention refers to a method for designing a medium access control (MAC) scheme that provides an efficient use of network resources and various ATM services in an ATM-based passive optical network (PON).

### DESCRIPTION OF THE PRIOR ART

At present, the ATM-PON system is established and is used as an economical way of establishment adequate for providing wideband service. As a subscriber network structure, the ATM-PON system has multiplexing generated in its upstream. So, MAC protocol should be employed to cope with the multiplexing effect. In fact, there are many MAC protocol propositions suggesting tree algorithm to solve the conflict. However, this algorithm does not perform well enough when time-sensitive traffic in priority is coming in.

Generally, many telecommunication companies are adopting an applicable wideband PON system. Providing from low-speed synchronization service such as voice to high-speed service like LAN interconnection, the PON system should not affect the performance of service.

Normally, the PON uses an optical distribution network (ODN), a distribution network, between the Fiber To The Home (FTTH) or Fiber To The Office (FTTC) subscriber access node and optical network unit (ONU), and all nodes are topologies dispersed in the form of bus or tree topology.

To access to an optical subscriber's network, the PON system includes ONUs established inside homes or companies and Optical Line Terminations (OLT) set up at telephone companies that are connected with each ONU through optical cables. Through each of the OLT, provided is an Internet service, Plain Old Telephone Service (POTS), video on demand (VOD) service and others.

PON technology has advantages of users capable of sharing exchange equipments and optical resources, low maintenance expenses due to passive optical distribution network, high flexibility of a service provider adding or deleting splits easily, and low per-subscriber cost because of high-level resource-sharing.

However, the problem of collision arises among users because many users are sharing optical resources in the PON. This collision happens more than often in an ATM-PON environment supporting multi-media traffic environment, which leads to bad performance.

Therefore, MAC technology transmitting information without any collision among users and using network resources efficiently is in need in the PON system.

### SUMMARY OF THE INVENTION

It is, therefore, an object of the present invention to provide a method of medium access control (MAC) that defines an upstream/downstream transmission frame, sends and reserves local cell arrival information of ONU for information transmission by using the upstream frame and to get a grant for it, utilizes a bandwidth allocation algorithm on a cell basis to secure the QoS of ATM traffic.

In accordance with an aspect of the present invention, there is provided a method for transmitting a medium access control (MAC) protocol data between multiple groups of optical network units (ONU) and an optical line termination (OLT) in an asynchronous transfer mode passive optical network (ATM-PON), the method comprising the steps of: a) at the group of ONUs, transmitting an upstream frame to the OLT, wherein the upstream frame includes divided-slots having a plurality of minislots and each of the minislots has information on the number of real-time cells and non-real-time cells that have arrived at a corresponding ONU of the group of ONUs; and b) at the OLT, transmitting a downstream frame to the ONU, wherein the downstream frame includes PLOAM cells having a divided-slot grant field, a PLOAM grant field and a data grant field that being allocated with different bits of identifier, which the divided-slot grant field, the PLOAM grant field and the data grant field are distinctive to each other, wherein a quality of service (QoS) class field for distinguishing the real-time from the non-real-time cell is allocated to the data grant field.

In accordance with another aspect of the present invention, there is provided a method of medium access control (MAC) for reciprocal data transmission between a plurality of optical network unit (ONU) and an optical line termination (OLT) in an asynchronous transfer mode passive optical network (ATM-PON), the method comprising the steps of: a) the ONU determining the kind of a received grant from the identification bit inside a PLOAM cell of the downstream from the OLT; b) if the received grant is a divided-slot grant, calculating information on real-time cells and non-real-time cells that have arrived during the previous frame before receiving the divided-slot grant; c) transmitting the cell information calculated in the step b) to a corresponding slot through a minislot of the divided-slot; and d) if the received grant is a data grant, transmitting cells in a corresponding buffer to a corresponding slot and thus transmitting a corresponding frame to the OLT.

In accordance with further another aspect of the present invention, there is provided a method of medium access control (MAC) for reciprocal data transmission between a plurality of optical network unit (ONU) and an optical line termination (OLT) in an asynchronous transfer mode passive optical network (ATM-PON), the method comprising the steps of: a) at the OLT, dividing 53 slots to be transmitted for a frame into groups as much as a number of segments; b) allocating data grant on real-time traffic to the remaining slots left after allocation of divided-slot grants to a corresponding group is completed; and c) if there is no slot to be allocated to the data grant in a corresponding group, the grants being allocated in the empty slots of the next group.

In accordance with still further another aspect of the present invention, there is provided a computer-readable recording medium for recording a program in an optical network unit (ONU) that realizes a medium access control (MAC) protocol with an optical line termination (OLT) in an asynchronous transfer mode passive optical network (ATM-PON), the method comprising the steps of; g) determining the kind of a received grant from an identification bit in the downstream frame PLOAM cell from the OLT; h) if the received grant is a divided-slot grant, calculating information of the real-time/non-real-time cells that have arrived during the previous frame before receiving the divided-slot grant; i) transmitting the cell information calculated in the step h) to a corresponding slot through a minislot of the divided-slot; and j) if the received grant is a data grant, transmitting a cell in a corresponding buffer to a corresponding slot.

In accordance with yet another aspect of the present invention, there is provided a computer-readable recording medium for recording a program in an optical line termination (OLT) that realizes a medium access control protocol with a plurality of optical network units (ONU) in an asynchronous transfer mode passive optical network (ATM-PON), the method comprising the steps of: a) at the OLT, dividing 53 slots to be transmitted for a frame into groups as much as a number of segments; b) allocating data grant on real-time traffic to the remaining slots left after allocation of divided-slot grants to a corresponding group is completed; and c) if there is no slot to be allocated to the data grant in a corresponding group, the grants being allocated in the empty slots of the next group.

In accordance with yet another aspect of the present invention, there is provided an optical network unit (ONU) for realizing a medium access control (MAC) protocol with an optical line termination (OLT) in an asynchronous transfer mode passive optical network (ATM-PON), the ONU comprising: a cell arrival monitor for, if a divided-slot grant in the downstream PLOAM cell from the OLT, calculating information of real-time and non-real-time cells that have arrived during the previous frame before receiving the divided-slot grant; a minislot assembler for making a plurality of minislot formats including each cell information from the respective ONUs calculated at the cell arrival monitor and transmitting them to a frame assembler, and a cell scheduler for, if a data grant in the downstream cell from the OLT is allocated and the grant is of non-real-time traffic, selecting one out of a plurality of non-real-time traffic buffers and transmitting the data cell in the selected buffer to the frame assembler.

In accordance with yet another aspect of the present invention, there is provided an optical line termination (OLT) for embodying a medium access control protocol with a group of optical network units (ONU) in an asynchronous transfer mode passive optical network (ATM-PON), the OLT comprising: a unit for being transmitted with real-time cell arrival information from the divided-slot received from the group of ONUs, storing it in a corresponding register according to an ONU, and allocating data grant for real-time traffic; a unit for receiving non-real-time cell arrival information from the divided-slot, storing it in a corresponding register according to each ONU, and allocating a data grant for non-real-time traffic; a first grant memory for being allocated with a divided-slot grant and a real-time data grant from the unit for allocating real-time traffic data grant so that the real-time cell corresponding to each segment of the upstream frame through the real-time cell arrival information stored in each register; and a second grant memory for being allocated with a divided-slot grant and a non-real-time data grant from the unit for allocating non-real-time traffic data grant so that the non-real-time cell corresponding to each segment of the upstream frame through the non-real-time cell arrival information stored in each register.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram showing a passive optical network (PON) of tree topology in accordance with the present invention;

FIG. 2 is a diagram showing a transmit frame of a symmetric PON whose upstream and downstream are 155.52 and 155.52 Mbps respectively in accordance with the PON of FIG. 1;

FIG. 3 is a diagram showing a transmit frame of an asymmetric PON whose upstream and downstream are 155.52 and 622.08 Mbps respectively in accordance with the PON of FIG. 1;

FIG. 4 is a diagram illustrating the downstream PLOAM cell payload content of the transmit frame in FIGS. 2 or 3;

FIG. 5 is a diagram depicting the format of a grant field defined in accordance with an embodiment of the present invention;

FIG. 6 is a diagram depicting the format of a divided slot defined in accordance with an embodiment of the present invention;

FIG. 7 is a block diagram illustrating the function of a medium access controller at an optical line termination (OLT) in an embodiment of the present invention;

FIG. 8 is a structural diagram of a grant selector showing real-time traffic in the medium access controller at an OLT in an embodiment of the present invention;

FIG. 9 is a structural diagram of a grant selector showing non-real-time traffic of the medium access controller at the OLT in an embodiment of the present invention;

FIG. 10 is a block diagram illustrating the function of the medium access controller at an optical network unit (ONU) in an embodiment of the present invention; and

FIG. 11 is a diagram showing the operation of the grant selector on the real-time traffic of the medium access controller at an OLT in an embodiment of the present invention.

### DETAILED DESCRIPTION OF THE PREFERRED EMBODIMENTS

Other objects and aspects of the invention will become apparent from the following description of the embodiments with reference to the accompanying drawings, which is set forth hereinafter.

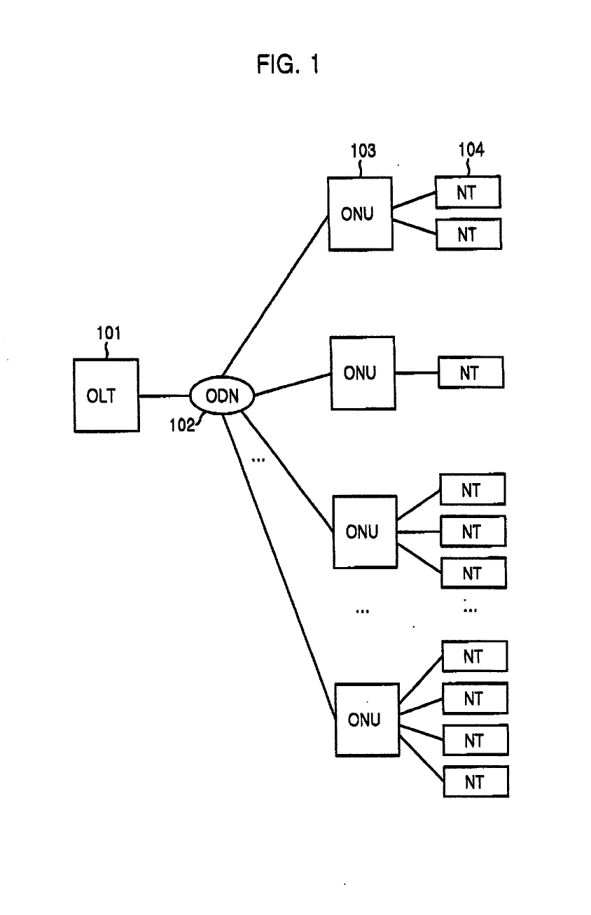

FIG. 1 is a block diagram of a passive optical network (PON) of tree topology in accordance with the present invention. The PON system comprises an OLT 101 which being situated in the root of the tree topology, plays a pivotal role for providing information to subscribers of an access network, an ONU 103 for connecting a plurality of NTs 104 to the OLT 101, and an ODN 102 which being situated between the ONU 103 and the OLT 101, has tree topology,

In the preferred embodiment of the present invention, it is the OLT 101 that implements bandwidth allocation algorithm where a variety of ATM traffics are considered.

To briefly describe the implementation of the protocol embodied in this invention, if a reservation is requested through the upstream frame, grant information which is generated from the cell-unit bandwidth allocation algorithm to secure the QoS of ATM traffic is sent to a corresponding ONU 103 among a plurality of ONUs through the downstream frame.

Getting grant for that reservation request, the ONU 103 refers to the received grant information and transmits information to the OLT. In the preferred embodiment of the present invention, the one single grant information means that it uses one single slot of the upstream frame in the ONU 103. The bandwidth for the upstream frame is allocated in priority order to satisfy the QoS considering characteristics of ATM traffic.

Referring to exemplary embodiments, the structure of the upstream/down-stream frame will be described more in detail, hereinafter.

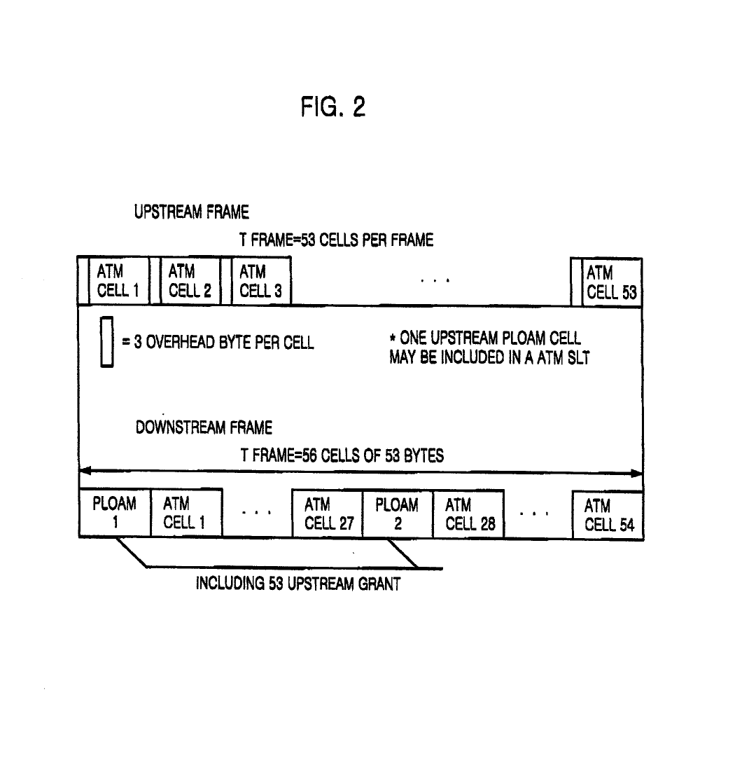

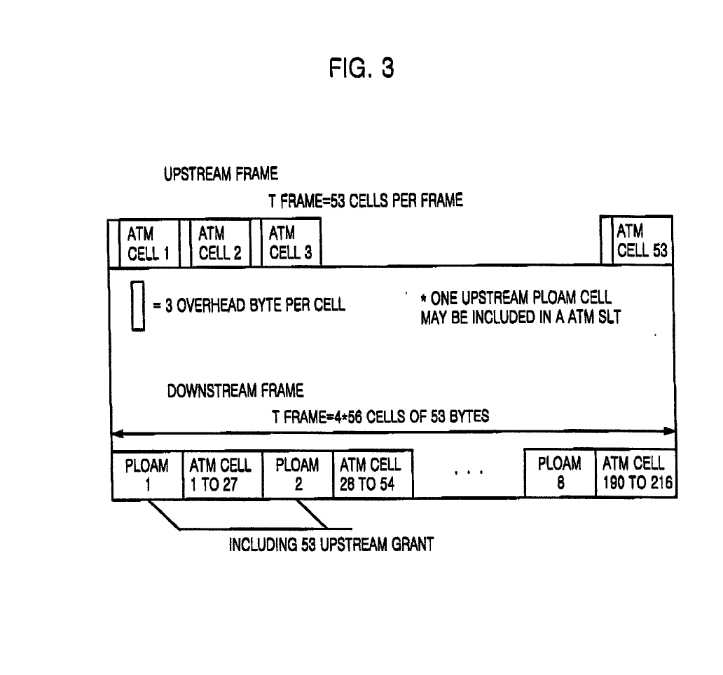

FIG. 2 is a diagram showing a transmit frame structure of a symmetric PON whose upstream and downstream are 155.52 and 155.52 Mbps, while FIG. 3 shows a transmit frame structure of an asymmetric PON whose upstream and downstream are 155.52 and 622.08 Mbps, respectively. As seen in FIGS. 2 and 3, the downstream interface structure for both 155.52 Mbps and 62.08 Mbps contains 53 octets of continuous ATM cells or PLOAM cells, and a PLOAM cell is inserted in every 28^{th} time slot. In case of 155.52 Mbps, the downstream frame contains two PLOAM cells in 56 slots and in case of 622.08 Mbps, there are eight PLOAM cells in 224 slots, while the upstream frame contains 53 56-byte time slots. So, we can see that the downstream cell rate of an asymmetric PON is four times as big as that of a symmetric PON.

Capable of transmitting 53 cells in a single upstream frame, the number of grants the OLT should send to the ONU through one downstream frame is 53. The information of 53 grants is carried in the first two PLOAM cells of the downstream frame.

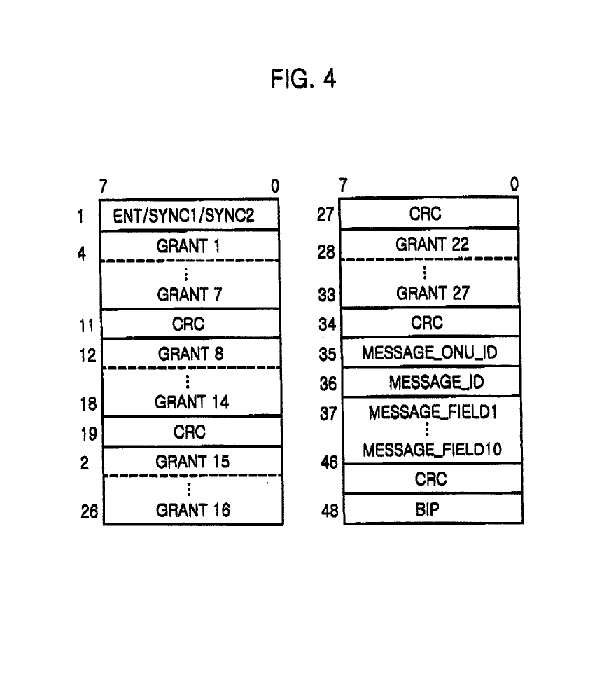

FIG. 4 is a diagram illustrating the downstream PLOAM cell payload content on a byte basis according to an embodiment of the present invention. The downstream PLOAM cell includes 27 one-byte grant fields. Among the kinds of grants the OLT 101 sends to the ONU 103 are a data grant, PLOAM grant, divided-slot grant, reserved grant, ranging grant, unassigned grant and an idle grant. As the OLT should send 53 grants in one downstream frame, the last grant field of the second PLOAM slot and the grant fields of the following PLOAM cell are all filled up with idle grants.

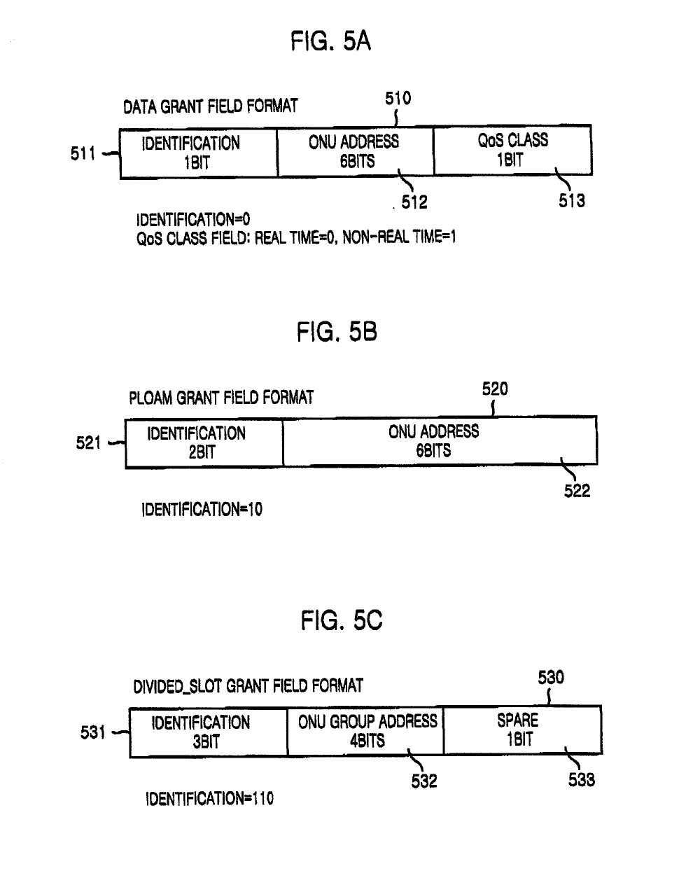

In accordance with an embodiment of the present invention, the data grant field 510, PLOAM grant field 520 and divided-slot grant field 530 included in the downstream PLOAM cell are illustrated in FIG. 5.

Referring to FIG. 5, the data grant field 510 is composed of a one-bit identification field 511, six-bit ONU address field 512 and one-bit QoS class field 513.

The one-bit identification field 511 is used to indicate that a certain grant is a data grant, and chooses ‘0’ in the preferred embodiment of the present invention. Also, the six-bit ONU address field 512 is used to show the address of an ONU a grant is allocated to, and up to 64 ONUs largest can be differently indicated according to the preferred embodiment of the present invention. The one-bit QoS class field 513 is used to indicate if a certain data grant is allocated to real-time traffic or non-real-time traffic, and in the preferred embodiment of the present invention, if it's allocated to real-time traffic, the value ‘0’ is given, otherwise being allocated to non-real-time traffic, ‘1’ is given.

The PLOAM grant 520 is composed of a two-bit identification field 521 and a six-bit ONU address field 522. The two-bit identification field 521 is used to express that a certain grant is a PLOAM grant, and in this preferred embodiment of the present invention, its value is set to be ‘10.’ The six-bit ONU address field 522 is used to express the address of an ONU a grant is allocated to, and in this preferred embodiment of the present invention, up to 64 ONUs largest can be differently indicated.

The divided-slot grant field 530 is composed of a three-bit identification field 531, four-bit ONU group address field 532 and one-bit spare bit 533. The three-bit identification field 531 is used to indicate that a grant is a divided-slot grant, and in this preferred embodiment of the present invention, its value is set to be ‘110.’ Also, the six-bit ONU group address field 532 is used to express the address of an ONU group a corresponding grant is allocated to, and in this preferred embodiment of the present invention, up to 16 ONU groups at largest can be differently indicated. Also, according to the preferred embodiment of the present invention, one ONU group consists of four ONUs.

The ONU group that has received a divided-slot grant 530 expresses on the upstream frame divided-slot the information on the number of cells, which have arrived in a corresponding ONU, and transmits it to the OLT. In accordance with the preferred embodiment of the present invention, the divided-slot is composed of a plurality of minislots, each minislot expressed with the information on the number of cells that have arrived at each ONU.

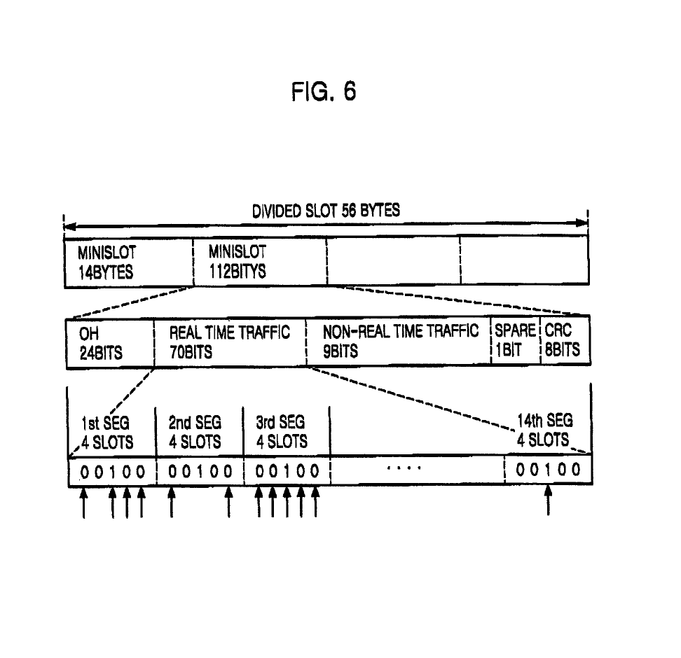

An embodiment of a divided-slot format is illustrated in FIG. 6. In the preferred embodiment of the present invention, a single divided-slot includes four minislots, each minislot being formed of 14 bytes, that is, 112 bits. The minislot is composed of a 24-bit overhead field, 70-bit real-time cell arrival number field, 9-bit non-real-time cell arrival number field, one-bit spare field and eight-bit CRC field.

In case of real-time service, to express cell arrival information more precisely, each ONU divides a frame into 14 segments. Then each segment gets to have four time slot resolutions, which expresses the number of real-time traffic cells having arrived during each segment in five bits. Therefore, the 70-bit real-time cell arrival number field shows cell arrival information from all the 14 segments. In case of non-real-time service, the nine-bit non-real-time cell arrival number field is used to indicate the number of non-real-time cells that have arrived.

The bandwidth allocation method will be described more in detail, hereinafter, applying such a frame format as above and considering the ATM traffic characteristics.

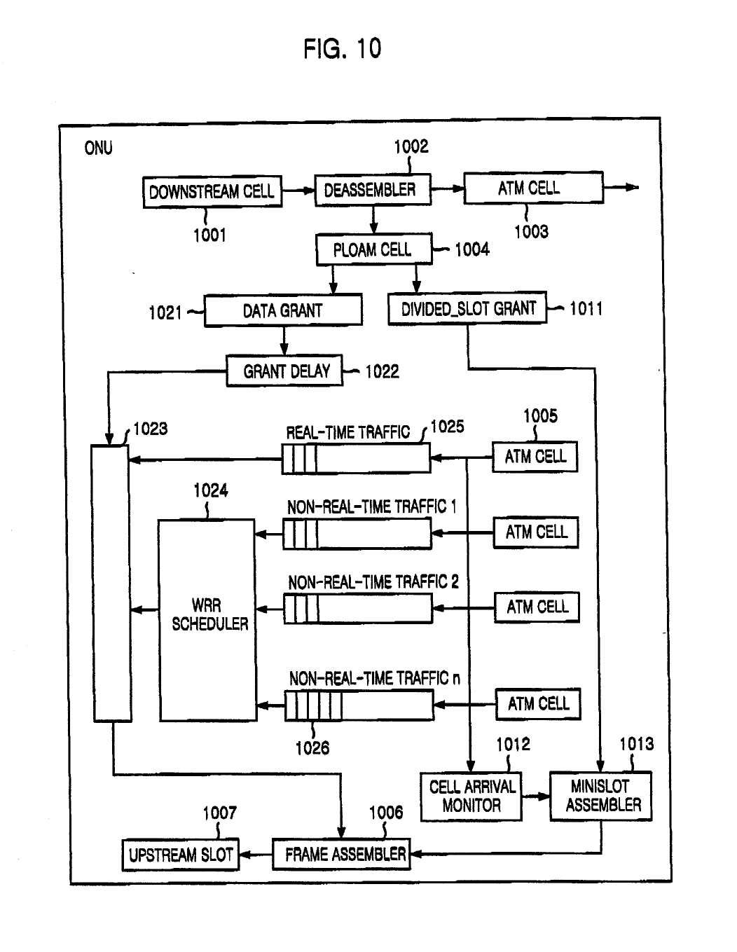

The internal structure of an optical network unit (ONU) in accordance with the preferred embodiment of the present invention is illustrated in detail in FIG. 10. Referring to FIG. 10, each ONU of a group of ONUs where the divided-slot grant 1011 in the downstream PLOAM cell 1004 from the OLT is allocated to includes a cell arrival monitor 1012 for calculating real-time cells and non-real-time cells that have arrived in a corresponding ONU during the previous frame before receiving the divided-slot grant 1011, and the calculated number of cells is made into a minislot format at a minislot assembler 1013 and transmitted to the OLT through a frame assembler 1006 and an upstream slot 1007.

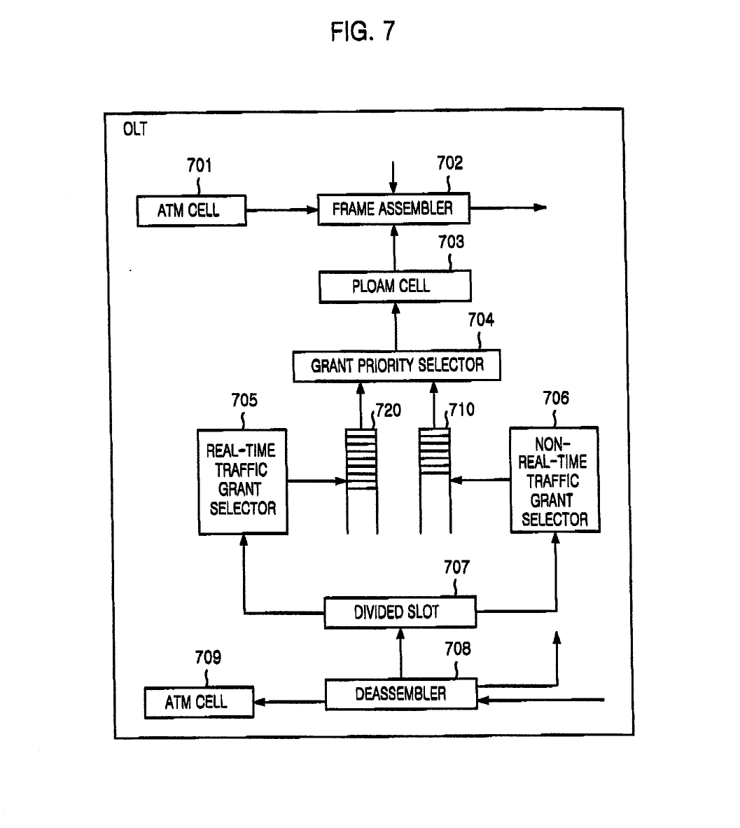

Meanwhile, the internal structure of the OLT in accordance with the preferred embodiment of the present invention is shown in detail in FIG. 7. The OLT receives information on the number of cells arrived for a certain frame from all ONUs via the divided-slot 707, sends the number of real-time arrival cells and the number of non-real-time arrival cells to grant selectors 705, 706 respectively and stores it in a corresponding register according to each ONU. Each grant selector 705, 706 allocates a divided-slot grant and data grant to grant memories 710, 720. This invention makes the bandwidth of the upstream frame allocated dynamically by endowing priority to grants stored in the grant memories 710, 720 through the grant priority selector 704 so that the QoS should be satisfied.

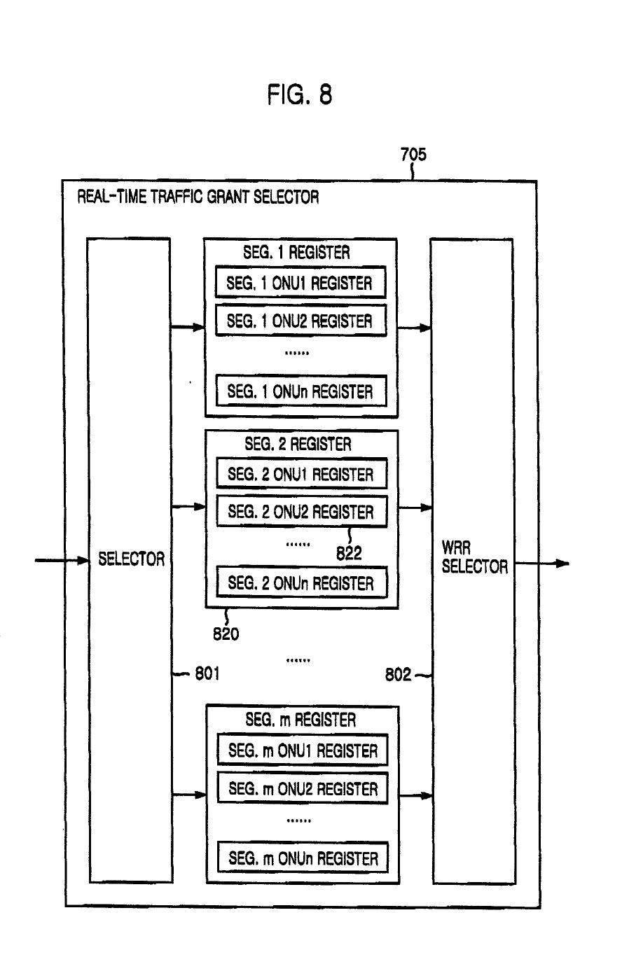

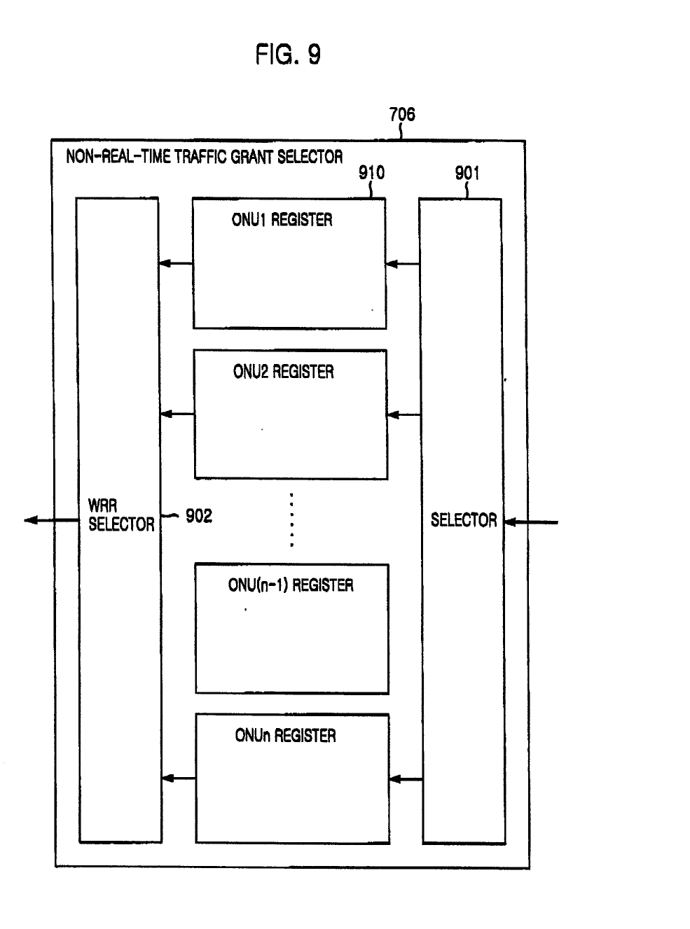

FIG. 8 is a detailed figure of the real-time grant selector 705 and FIG. 9, of the non-real-time grant selector 706.

Referring to FIG. 8, the real-time grant selector 705 classifies at the selector 801 the number of real-time arrival cells of the ONU transmitted through the divided-slot 707, stores it in the corresponding register 822 of a segment according to each segment 820, and the OLT allocates data grants to a divided-slot grant and real-time data grant memory 720 so that real-time cells can be transmitted to each segment of the upstream frame with the help of the real-time cell arrival information stored according to a segment. Here, the allocation procedure in each segment is implemented at the WRR selector 802, which conducts spacing treatment. The selector 802 adopts a WRR method which has the number of cells as weight, and keeps grants allocated according to each ONU at regular interval in a segment to reduce cell delay variance (CDV). The number of non-real-time cell arrivals is stored in the corresponding register 910 of each ONU.

Meanwhile, the grants of non-real-time cells of each ONUs are allocated to a non-real-time data grant memory 710 according to the WRR method having the number of cells as weight. The non-real-time data grants are not allocated to real-time cells but to slots left in each segment. FIG. 9 illustrates a detailed figure of the non-real-time grant selector 706. As FIG. 9 has a similar constitute to that of FIG. 8, some details have been omitted to present a simple figure.

Referring to FIG. 10 again, when an ONU receives a data grant 1021, if the data grant is of real-time traffic, the ONU transmits a cell in the waiting row 1025 of real-time traffic, otherwise, the ONU selects one from a plurality of non-real-time traffic waiting row 1026 and transmits it to the OLT through the cell scheduler 1024 that has a WRR method.

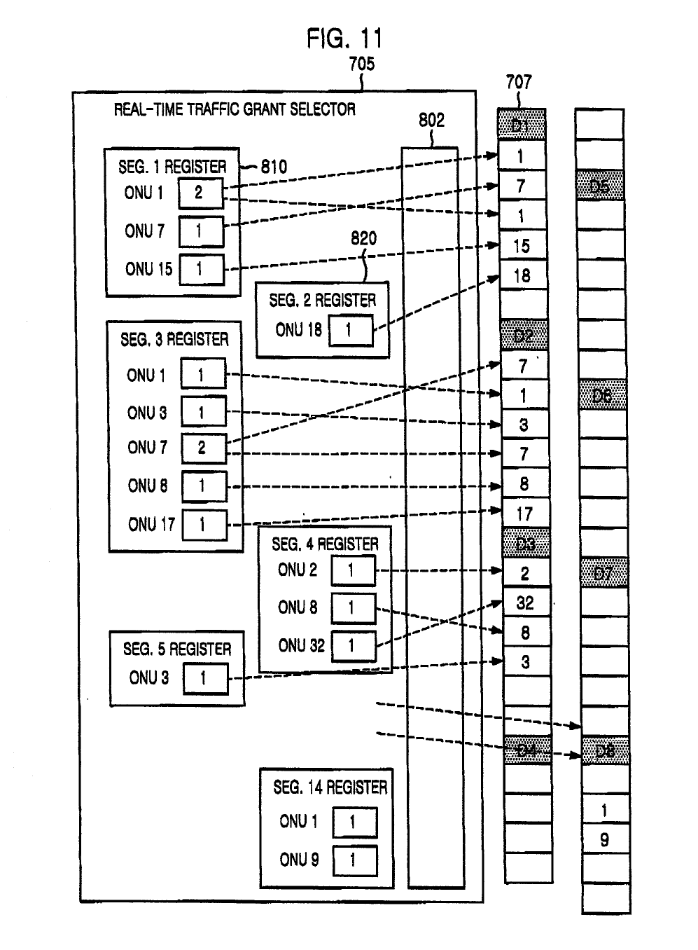

Referring to FIG. 11, the operation of grant allocation algorithm for real-time traffic will be described hereinafter.

As seen in FIG. 11, in the first place, a divided-slot and real-time data grant memory 707 is divided into 14 memory segments of 4,3, 4,3, 4,3, 4,3, 4,3, 4,4, 5, 5,4 slots, and the divided-slot grants are allocated to empty slots of the memory 707 to D1, D2, D3, D4, DS, D6, D7 and D8. Then the data grant that has arrived at an ONU during each segment is allocated at as regular intervals as possible. In case there is no empty slot in a corresponding memory segment to allocate data grants that have arrived during each segment, the rest of the grants should be allocated to the empty slots of the next segment continuously.

For instance, as shown in FIG. 11, it is assumed that two cells have arrived at the ONU1, a cell at the ONU7 and a cell at the ONU15 during a first segment 810, and during a second segment 820 a cell is to arrive at the ONU18, and for the rest segments have cells arrived at each ONU as described in FIG. 11. Then, the number of cells that have arrived during the first segment is four, larger than the number of empty slots of the first memory segment of the divided-slot and real-time data grant memory 707, which is three. So, the data grant for the cells that have arrived during the first segment 810 is allocated to the first slot of the second memory segment. The two cells that have arrived at the ONU1 during the first segment 810 is allocated into the second and fourth slots of the four slots between the second slot of the memory 707 and its fifth slot so that they are arrayed at regular intervals.

Using the MAC scheme of the present invention, there are advantages of raising the utility rate of the upstream transmit channel and efficient transmission as well as providing diverse multi-media services. Since a plurality of users can use high-cost optical resources in the form of sharing efficiently, it also brings economical effect.

While the present invention has been described with respect to certain preferred embodiments, it will be apparent to those skilled in the art that various changes and modifications may be made without departing from the scope of the invention as defined in the following claims.

What is claimed is:

1. A method for transmitting a medium access control (MAC) protocol data between multiple groups of optical network units (ONU) and an optical line termination (OLT) in an asynchronous transfer mode passive optical network (ATM-PON), the method comprising the steps of:
a) at the group of ONUs, transmitting an upstream frame to the OLT, wherein the upstream frame includes divided-slots having a plurality of minislots and each of the minislots has information on the number of real-time cells and non-real-time cells that have arrived at a corresponding ONU of the group of ONUs; and
b) at the OLT, transmitting a downstream frame to the ONU, wherein the downstream frame includes PLOAM cells having a divided-slot grant field, a PLOAM grant field and a data grant field that being allocated with different bits of identifier, which the divided-slot grant field, the PLOAM grant field and the data grant field are distinctive to each other,
wherein a quality of service (QoS) class field for distinguishing the real-time from the non-real-time cell is allocated to the data grant field.

2. The method as recited in claim 1, wherein the divided-slot includes 56 bytes, which is divided into four 14-byte minislots.

3. The method as recited in claim 1, wherein one bit is allocated to the identification field of the data grant field, two bits to the identification field of the PLOAM grant field, and three bits to the identification field of the divided-slot grant field.

4. The method as recited in claim 3, wherein the data grant field includes the one-bit identification field, an ONU address field for indicating an address of the ONU to which a grant is allocated, and the QoS class field.

5. The method as recited in claim 3 , wherein the PLOAM grant field includes the two-bit identification field and an ONU address field for indicating an address of the ONU to which a grant is allocated.

6. The method as recited in claim 3, wherein the divided-slot grant field includes the three-bit identification field, an ONU address field for indicating an address of the group of ONUs to which a grant is allocated, and a spare bit.

7. The method as recited in claim 2, wherein each minislot of the upstream frame includes 24 bits of an overhead field 70 bits of a real-time cell arrival number field which indicates the number of real-time cell arrivals, nine bits of a non-real-time call arrival number field which indicates the number of non-real-time cell arrivals, one bit of a spare field and eight bits of a CRC field.

8. The method as recited in claim 7, wherein the real-time cell arrival number field is divided into 14 5-bit segments, the number of real-time cells arrived for every four slots is transmitted to the OLT, such that cell delay variance (CDV) of the real-time cells can be reduced.

9. A method of medium access control (MAC) for reciprocal data transmission between a plurality of optical network unit (ONU) and an optical line termination (OLT) in an asynchronous transfer mode passive optical network (ATM-PON), the method comprising the steps of:
a) at the ONU, determining a kind of a received grant from the identification bit inside a PLOAM cell of the downstream from the OLT;
b) if the received grant is a divided-slot grant, calculating information on real-time cells and non-real-time cells that have arrived during the previous frame before receiving the divided-slot grant;
c) transmitting the cell information calculated in the step b) to a corresponding slot through a minislot of the divided-slots; and
d) if the received grant is a data grant, transmitting cells in a corresponding buffer to a corresponding slot and thus transmitting a corresponding frame to the OLT.

10. The method as recited in claim 9, further comprising the steps of;
e) if the received grant is a data grant, the ONU analyzing the allocated QoS class field to classify real-time traffics and non-real-time traffics in the data grant field format; and
f) if the grant of the step e) is one allocated to real-time traffic, transmitting the cell in the real-time traffic buffer to a corresponding slot, or if the grant is one allocated to non-real-time traffic, transmitting the non-real-time cell to a corresponding slot.

11. The method as recited in claim 10, wherein the non-real-time cell selection is performed through an algorithm in order of weight.

12. The method as recited in claim 9, wherein if a divided-slot is received from the ONU, the OLT performs the steps of:
a) dividing the number of cell arrivals in each minislot of the divided-slot received above by the number of real-time cells and non-real-time cells when receiving a divided-slot;
b) storing the number of real-time and non-real-time cells in corresponding registers according to each ONU; and
c) allocating the divided-slot grant and real-time/non-real-time data grant so that corresponding real-time cells are transmitted to the upstream frame to be transmitted according to the number of the real-time and non-real-time cells stored in the registers, and the non-real-time data grant being allocated in the slots left after the divided-slot grant allocation of a corresponding group is completed.

13. The method as recited in claim 12, wherein the data grant allocation is conducted through a weight priority algorithm using the number displayed on the register of each ONU as weight.

14. A method of medium access control (MAC) for reciprocal data transmission between a plurality of optical network unit (ONU) and an optical line termination (OLT) in an asynchronous transfer mode passive optical network (ATM-PON), the method comprising the steps of:
a) at the OLT, dividing 53 slots to be transmitted for a frame into groups as much as a number of segments;
b) allocating data grant on real-time traffic to the remaining slots left after allocation of divided-slot grants to a corresponding group is completed; and
c) if there is no slot to be allocated to the data grant in a corresponding group, the grants being allocated in the empty slots of the next group.

15. The method as recited in claim 14, wherein the OLT allocates data grant on non-real-time traffic into the slots left after the allocation of divided-slot grant and data grant on real-time traffics are completed.

16. The method as recited in claim 14, wherein the allocation to the above slots employs a weight priority algorithm having the number displayed on the register of each ONU as weight.

17. A computer-readable recording medium recording instructions for executing a method of medium access control (MAC) protocol between an optical line termination (OLT) and a plurality of optical network units (ONU) in an asynchronous transfer mode passive optical network (ATM-PON), the method comprising the steps of:
a) determining the kind of a received grant from an identification bit in the downtown frame PLOAM cell from the OLT;
b) if the received grant is a divided-slot grant, calculating information of the real-time/non-real-time cells that have arrived during the previous frame before receiving the divided-slot grant;
c) transmitting the cell information calculated in the step b) to a corresponding slot through a minislot of the divided-slots; and
d) if the received grant is a data grant, transmitting a cell in a corresponding buffer to a corresponding slot.

18. A computer-readable recording medium recording instructions for executing a method of a medium access control protocol between an optical line termination (OLT) and a plurality of optical network units (ONU) in an asynchronous transfer mode passive optical network (ATM-PON), the method comprising the steps of:
a) at the OLT, dividing 53 slots to be transmitted for a frame into groups as much as a number of segments;
b) allocating data grant on real-time traffic to the remaining slots left after allocation of divided-slot grants to a corresponding group is completed; and
c) if there is no slot to be allocated to the data grant in a corresponding group, the grants being allocated in the empty slots of the next group.

19. An optical network unit (ONU) for realizing a medium access control (MAC) protocol with an optical line termination (OLT) in an asynchronous transfer mode passive optical network (ATM-PON), the ONU comprising:
a cell arrival monitor for, if a divided-slot grant in the downstream PLOAM cell from the OLT, calculating information of real-time and non-real-time cells that have arrived during the previous frame before receiving the divided-slot grant;
a minislot assembler for making a plurality of minislot formats including each cell information from the respective ONUs calculated at the cell arrival monitor and transmitting them to a frame assembler; and
a cell scheduler for, if a data grant in the downstream cell from the OLT is allocated and the grant is of non-real-time traffic, selecting one out of a plurality of non-real-time traffic waiting rows and transmitting it to the frame assembler.

20. The optical network unit (ONU) as recited in claim 19, wherein in case a data grant in the downstream cell from the OLT is allocated and the grant is of real-time traffic, the cell of real-time traffic waiting rows is transmitted to the OLT through the frame assembler.

21. The optical network unit (ONU) as recited in claim 19, wherein the cell scheduler selects a non-real-time cell through a weight priority algorithm.

22. An optical line termination (OLT) for embodying a medium access control protocol with a group of optical network units (ONU) in an asynchronous transfer mode passive optical network (ATM-PON), the OLT comprising:
means for receiving real-time cell arrival information from the divided-slot from the group of ONUs, storing it in a corresponding register according to an ONU, and allocating data grant for real-time traffic;
means for receiving non-real-time cell arrival information from the divided-slot, storing it in a corresponding register according to each ONU, and allocating a data grant for non-real-time traffic;
a first grant memory for being allocated with a divided-slot grant and a real-time data grant from the means for allocating real-time traffic data grant so that the real-time cell corresponding to each segment of the upstream frame through the real-time cell arrival information stored in each register; and
a second grant memory for being allocated with a divided-slot grant and a non-real-time data grant from the means for allocating non-real-time traffic data grant so that the non-real-time cell corresponding to each segment of the upstream frame through the non-real-time cell arrival information stored in each register.

23. The optical line termination (OLT) as recited in claim 22, further including a grant priority selection means for giving priority to the frame allocated to the first and the second grant memories.

24. The optical line termination (OLT) as recited in claim 22, wherein the data grant allocation to the first grant memory is performed by a selector that allocates grants to each segment according to each ONU of the first grant memory through a weight priority algorithm using the number of cells as weight.

25. The optical line termination (OLT) as recited in claim 22, wherein the data grant allocation to the second grant memory is conducted by a selector that allocates grants to the remaining slot of each segment, which real-time cell are not allocated to, according to each ONU of the second grant memory through a weight priority algorithm using the number of cells as weight.
